(19) United States
(12) Patent Application Publication
(10) Pub. No.: US 2025/0138818 A1
(43) Pub. Date: May 1, 2025

(54) EFFICIENT GENERATION OF CODE DEVELOPMENT SUMMARIES

(71) Applicant: Microsoft Technology Licensing, LLC, Redmond, WA (US)

(72) Inventors: Crystal Annar EDWARDS, Redmond, WA (US); Alexandre ZOLLINGER CHOHFI, Bothell, WA (US)

(21) Appl. No.: 18/498,858

(22) Filed: Oct. 31, 2023

(51) Int. Cl. G06F 8/73

(52) U.S. Cl. CPC G06F 8/73

(57) ABSTRACT

Methods, computer systems, computer-storage media, and graphical user interfaces are provided for efficiently generating code development summaries. In embodiments, commit message data for a commit message associated with code is obtained. In embodiments, the commit message includes a description associated with a corresponding modification in the code. Thereafter, a model prompt to be input into a large language model is generated. The model prompt includes the commit message data. As output from the large language model, a code development summary is obtained that summarizes the commit message data for the commit message associated with the code.

### BACKGROUND

Code development is an important aspect for many organizations. As such, it has become increasingly desirable in many cases for a viewer of code (e.g., a programmer, manager, tester) to understand the development of the code and/or to understand what aspects of code have been modified or contributed to over a period of time. In other regards, descriptions of code development are valuable for individuals interested in using or consuming a product having the code. For example, as new product releases are announced, understanding the updates to the code provides valuable information to user of the code.

Manually reviewing such code aspects to provide code updates, however, can be tedious and time consuming, particularly for products associated with an extensive amount of modifications. For example, a user may need to access various services to identify the desired information, including remote services that host a remote or global code repository to identify information associated with master code. In addition to such manual tracking of information being tedious and time-consuming, such a manual process also requires and consumes computing resources to navigate the systems and identify the desired information.

Further, generating a summary that communicates the code modifications to a particular audience or various audiences can also be tedious and time consuming, and often overlooks aspects that may be important to a particular audience. In addition to the time consumed to manually generate a summary of code modifications, computing resources are unnecessarily consumed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating efficient generation of code development summaries. In this regard, code development summaries are efficiently and effectively generated in an automated manner such that the code development summaries may be presented to a user. Generating a code development summary in an automated manner reduces computing resources utilized to manually generate a code development summary. As described herein, in some cases, a generated code development summary may be presented to a potential consumer of a product having the code. In other cases, a generated code development summary may be presented to an individual associated with code development (e.g., a manager, a tester, a marketer). In either case, a user can be presented with a summary of code development, thereby reducing the additional computing resources consumed by a user otherwise manually identifying or creating such information.

In operation, to efficiently and effectively generate a code development summary, a machine learning model is used. As described in association with embodiments described herein, a machine learning model used to generate code development summaries in an automated manner may be in the form of a large language model (LLM). In this regard, aspects of the technology described herein facilitate programmatically generating a model prompt (prompt engineering) to input into the machine learning model to attain a desired output in the form of a code development summary. For example, for a code development summary associated with particular code, existing commit messages associated with the particular code can be obtained and/or selected and used in the model prompt to facilitate generation of an output in the form of a code development summary.

### BRIEF DESCRIPTION OF THE DRAWINGS

The technology described herein is described in detail below with reference to the attached drawing figures, wherein:

FIG. 1 is a block diagram of an exemplary system for facilitating efficient generation of code development summaries, suitable for use in implementing aspects of the technology described herein;

FIG. 2 is an example an example implementation for facilitating efficient generation of code development summaries, via a code development summary manager, in accordance with aspects of the technology described herein;

FIG. 3 provides a first example method for facilitating efficient generation of code development summaries, in accordance with aspects of the technology described herein;

FIG. 4 provides a second example method for facilitating efficient generation of code development summaries, in accordance with aspects of the technology described herein;

FIG. 5 provides a third example method for facilitating efficient generation of code development summaries, in accordance with aspects of the technology described herein; and

FIG. 6 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

An understanding of code development is generally valuable to various audiences. For example, providing modifications or updates made to code can be helpful to a product development manager in understanding progress or advancements made in association with a product. As another example, providing modifications or updates made to code since a previous product release can allow a consumer or potential consumer of a product to understand differences between a previous product version and a current or new product version. In these regards, code development can be valuable to various audiences that may be interested in software code development.

In conventional implementations, to understand code development, an individual(s) manually tracks down and reviews software feature creation and/or change instances. For example, commit messages associated with code can be identified and reviewed. In accordance with identifying such feature creation and/or change instances, the individual(s) can analyze the information (e.g., commit messages) and create a summary of the feature creations and changes. Reviewing and analyzing such modifications, however, can be a time-consuming process, particularly for code that is associated with an extensive amount of modifications. For example, a user may identify when code forks from a main branch, navigate to relevant pull request(s), open the pull request(s), and analyze data associated therewith, resulting in a time consuming and resource intensive process. Moreover, generating a summary that communicates the code modifications to a particular audience or various audiences can also be tedious and time consuming, and often overlooks aspects that may be important to a particular audience. Further still, many of these code development updates can be outdated and regard older versions of the code. In this regard, as code modifications can rapidly occur, previous code development summaries can be quickly outdated, thereby necessitating further review and analysis of code.

As such, reviewing and analyzing code modifications and, thereafter, generating summaries that are relevant and helpful to a particular audience(s) places a burden on the user and can unnecessarily consume computing resources, as well as consume the user's time. For instance, computing resources may be used to search for various commit messages associated with code and, thereafter, manually author a summary of the commit messages. Such computing resource consumption is compounded with the frequency of code modifications as well as the different target audiences interested in the code modifications.

Accordingly, embodiments of the present technology are directed to efficient and programmatic generation of code development summaries. In this regard, code development summaries are efficiently and effectively generated in an automated manner such that the code development summaries may be presented to a user. Generating a code development summary in an automated manner reduces computing resources utilized to manually review modifications and author a code development summary. For example, computing resources used to manually locate, read, and synthesize a set of code modifications (e.g., commit messages) into a manually authored code development summary are not needed. As described herein, in some cases, a generated code development summary may be presented to a potential consumer of a product having the code or a product manager associated with the code. In this way, a potential consumer or product manager, for example, is presented with a summary of code modifications to provide understanding of updates and changes, thereby reducing the additional computing resources consumed with the individual otherwise manually searching for and identifying code modifications associated with code.

In operation, to efficiently and effectively generate a code development summary, a machine learning model is used. As described in association with embodiments described herein, a machine learning model used to generate code development summaries in an automated manner may be in the form of an LLM. In this regard, aspects of the technology described herein facilitate generating a model prompt to input into the machine learning model to attain a desired output in the form of a code development summary. For example, for a code development summary associated with particular code modification data, a model prompt is programmatically generated and used to facilitate output in the form of a code development summary. The model prompt may be based on code modification data, such as commit messages, associated with particular code, or a portion thereof, which can be obtained and/or selected for generating the model prompt. For example, code modification data, such as a set of commit messages (e.g., from a defined start commit message to an end commit message), can be extracted in association with code (e.g., in association with a set of corresponding commits) and input into a model prompt for generating a code development summary.

Using technology described herein, a code development summary can be generated to provide an understanding of code modifications in a way that is effective for a particular audience. For example, a code development summary may be generated in a blog form that includes release notes associated with a new product or product version, a list of key aspects since a previous product release, and/or the like. Such a blog may be made available for potential consumers of a product to view and understand various modifications or updates associated with the product. As another example, a code development summary may be in a text form that is designed to provide an update to a manager or contributor of the code (e.g., developer) and, as such, provide information that can be used to improve or enhance the code or understand the status of the code development. The term code is used broadly herein and may be code associated with various types of products, such as a computer application or app, a website, a game, media, and/or the like.

Advantageously, using an LLM to generate code development summaries facilitates reducing computing resource consumption, such as computer memory and latency. In particular, code development summaries can be accurately generated without requiring training and/or fine-tuning of the model for the particular code or for a particular model output, such as the generated code development summary. Utilizing pre-trained models reduces computing resources consumed for performing training. Fine-tuning refers to the process of re-training a pre-trained model on a new dataset without training from scratch. Fine-tuning typically takes weights of a trained model and uses those weights as an initialization value, which is then adjusted during fine-tuning based on the new dataset. Particular embodiments described herein do not need to engage in fine-tuning by ingesting millions of additional data sources and billions of parameters and hyperparameters. As such, the models of various embodiments described herein are significantly more condensed. In accordance with embodiments described herein, the models do not require as much computational resources and/or memory because there is no need to access the billions of parameters, hyperparameters, or additional resources in the fine-tuning phase. As described, such parameters and resources must typically be stored in memory and analyzed at runtime and fine-tuning to make predictions, making the overhead extensive and unnecessary.

Accordingly, one technical solution is that embodiments can utilize pre-trained models without requiring fine-tuning. Another technical solution is utilizing the code modification data (e.g., commit message data) as an input prompt for the machine learning model as a proxy to fine-tuning. Each of these technical solutions has the technical effect of improving computing resource consumption, such as computer memory and latency, at least because not as much data (e.g., parameters) is stored or used for producing the model output and computational requirements otherwise needed for fine-tuning are not needed.

Another technical solution is receiving or determining an input size constraint of a model and determining the code modification data based on the input prompt size constraint. Certain models, such as LLMs, are constrained on data input size of a prompt due to computational expenses associated with processing those inputs. This technical solution has the technical effect of improving computing resource consumption, such as computer memory and latency, because not as much code modification data is stored or used as input for producing output in the form of code development summaries.

### Overview of Exemplary Environments for Facilitating Efficient Generation of Code Development Summaries

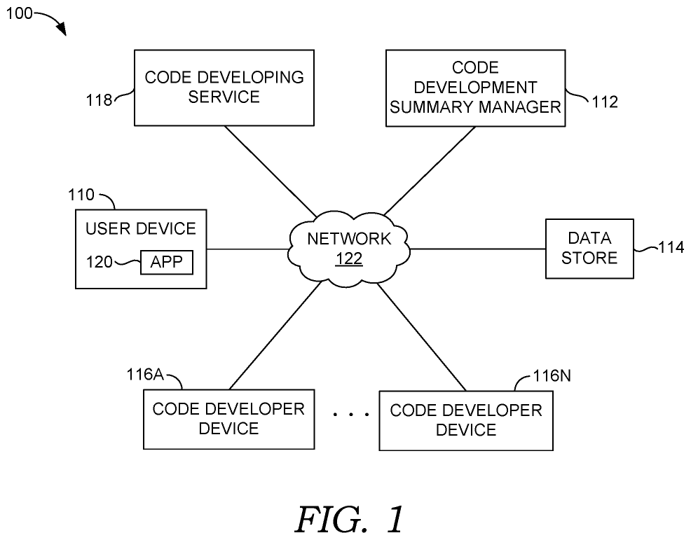

Referring initially to FIG. 1, a block diagram of an exemplary network environment 100 suitable for use in implementing embodiments described herein is shown. Generally, the system 100 illustrates an environment suitable for facilitating efficient generation of code development summaries. Among other things, embodiments described herein efficiently generate summaries of code development using code modification data. Generally, a code development summary may refer to any summary of code modification data, such as commit messages or commit message data, associated with code development. For example, commits are generally used by various developers (e.g., programmers, managers, or the like) in developing code. A commit generally refers to an operation that sends the latest changes of source code to a local repository, thereby making the changes part of a head or master revision of the repository. A commit message can be generated for a commit. A commit message generally refers to a descriptive text that is added to the commit object by the developer who made the commit. A commit message may be in any of a variety of forms, but oftentimes includes a title line and body text. Generally, the commit message is used to identify the changes made in the code and provide context for future reference. Often, the commit message indicates changes the commit makes to the behavior of the code and/or what is changed in the code. Accordingly, commit messages can be used to generate code development summaries in an automated manner. In particular, upon code modification data being collected in association with particular code or a particular code segment, a code development summary can be generated, via a LLM, that summarizes the collected data, or a portion thereof (e.g., a set of the collected code modification data associated with code). Advantageously, generating and providing a code development summary in an efficient manner enables a user viewing or interested in code to have a better understanding of the code without having to manually track down the desired data using various systems and queries thereto.

The network environment 100 includes user device 110, a code development summary manager 112, a data store 114, code developer devices 116a-116n (referred to generally as code developer device(s) 116), and code developing service 118. The user device 110, the code development summary manager 112, the data store 114, the code developer devices 116a-116n, and code developing service 118 can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document. Neither should the exemplary network environment 100 be interpreted as having any dependency or requirement related to any single component or combination of components illustrated therein. For example, the user device 110 and code developer devices 116a-116n may be in communication with the code development summary manager 112 and/or the code developing service 118 via a mobile network or the Internet, and the code development summary manager 112 and/or code developing service 118 may be in communication with data store 114 via a local area network. Further, although the environment 100 is illustrated with a network, one or more of the components may directly communicate with one another, for example, via HDMI (high-definition multimedia interface), and DVI (digital visual interface). Alternatively, one or more components may be integrated with one another. For example, at least a portion of the code development summary manager 112 and/or data store 114 may be integrated with the user device 110, code developer devices 116, and/or code developing service 118. For instance, a portion of the code development summary manager 112 may be integrated with a user device, while another portion of the code development summary manager 112 may be integrated with a code developing service 118.

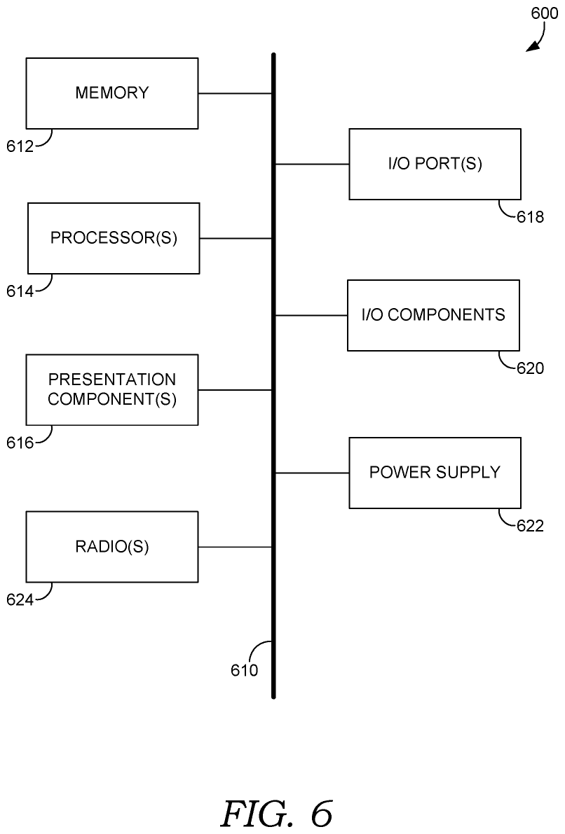

The user device 110 can be any kind of computing device capable of facilitating generating and/or providing code development summaries. For example, in an embodiment, the user device 110 can be a computing device such as computing device 600, as described above with reference to FIG. 6. In embodiments, the user device 110 can be a personal computer (PC), a laptop computer, a workstation, a mobile computing device, a PDA, a cell phone, or the like.

The user device can include one or more processors, and one or more computer-readable media. The computer-readable media may include computer-readable instructions executable by the one or more processors. The instructions may be embodied by one or more applications, such as application 120 shown in FIG. 1. The application(s) may generally be any application capable of facilitating generating and/or providing code development summaries. In some implementations, the application(s) comprises a web application, which can run in a web browser, and could be hosted at least partially server-side (e.g., via a server). In addition, or instead, the application(s) can comprise a dedicated application. In some cases, the application is integrated into the operating system (e.g., as a service). As one specific example application, application 120 may be a code developing tool or other integrated development tool that provides various tools for computer developers for software development, such as source code development or editing, build automation tools, and debugging tools.

User device 110 can be a client device on a client-side of operating environment 100, while code development summary manager 112 and/or code developing service 118 can be on a server-side of operating environment 100. Code development summary manager 112 and/or code developing service 118 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110, code development summary manager 112, and/or code developing service 118 to remain as separate entities.

In an embodiment, the user device 110 is separate and distinct from the code development summary manager 112, the data store 114, the code developer devices 116, and the code developing service 118 illustrated in FIG. 1. In another embodiment, the user device 110 is integrated with one or more illustrated components. For instance, the user device 110 may incorporate functionality described in relation to the code development summary manager 112 and/or code developing service 118. For clarity of explanation, embodiments are described herein in which the user device 110, the code development summary manager 112, the data store 114, the code developer devices 116, and the code developing service 118 are separate, while understanding that this may not be the case in various configurations contemplated.

As described, a user device, such as user device 110, can facilitate generating and/or providing code development summaries. Code development summaries generally refers to any summary or description associated with code development. Code development summaries are generally provided in the form of text, but other types of data may additionally or alternatively be used to provide a code development summary. In embodiments, code development summaries represent information or data associated with modifications applied to code, or a portion thereof.

A user device 110, as described herein, is generally operated by an individual or entity that initiates generation and/or viewing of a code development summary(s). In some cases, such an individual may be a contributor or programmer of code, a software product designer, a website designer, an application designer, a software product marketer, a software product manager, a software tester, a software product consumer, an individual interested in a software product, and/or the like. In this regard, the user may be interested in a code development summary, for example, to understand new developments of the code (e.g., for a new version or release of code). For instance, a product manager or marketer may be interested in understanding new developments in a recently released or upcoming release of a product. In other cases, such an individual may be a person interested in or a potential consumer of code. For example, a potential consumer of an application may navigate to an application store. Based on navigating to the application store, and/or searching for a particular application, the user may be provided with a code development summary for the particular version of the application (e.g., indicating new developments in the current version). As another example, a potential consumer may initiate a search for a product to view search results and be provided with a search result that includes a code development summary for the product.

In some cases, generation or provision of code development summaries may be initiated at the user device 110. For example, in some cases, a user may directly or expressly select to generate or view a code development summary(s) related to code, or code segment. To this end, a user of the user device 110 that may initiate generating and/or providing of a code development summary(s) is a user that performs some aspect of code development, marketing, or the like (e.g., via a link or query). As another example, a user interested in a software product (e.g., a potential product to purchase, download, or install) may select a link or icon to view a code development summary associated with the product. In other cases, a user may indirectly or implicitly select to generate or view a code development summary(s) related to code. For instance, a user may navigate to a media store application or website. Based on the navigation to the software store application or website, the user may indirectly indicate to generate or view a code development summary. In some cases, such an indication may be based on generally navigating to the application or website. For instance, a code development summary may be requested for each software product to be presented in the application or website or for a particular software product(s) being features or promoted. In other cases, such an indication may be based on selecting a particular software product.

Generating and/or providing code development summaries may be initiated and/or presented via an application 120 operating on the user device 110. In this regard, the user device 110, via an application 120, might allow a user to initiate generation or presentation of a code development summary(s). The user device 110 can include any type of application and may be a stand-alone application, a mobile application, a web application, or the like. In some cases, the functionality described herein may be integrated directly with an application or may be an add-on, or plug-in, to an application. One example of an application that may be used to initiate and/or present code development summaries includes any application in communication with a code developing service, such as code developing service 118. By way of example only, an application that may be used to initiate and/or present code development summaries in a code developing environment is Visual Studio® Code provided by Microsoft®. Another example of an application that may be used to initiate and/or present code development summaries includes a search application, a software store application, and/or the like.

Such generation and/or provision of code development summaries may be initiated at the user device 110 in any manner. For instance, upon accessing a particular application (e.g., a code developing application), a user may be presented with, or navigate to, options associated with a code development summary. As one example, a user may utilize the user device 110 to access code via a repository. In association with the code, or a portion thereof, a user may select to view a code development summary. For instance, a user may right click or hover over a portion of code and be presented with an option to view a code development summary. In some cases, the user may select to view a code development summary corresponding with a particular portion of code (e.g., associated with a set of commits). For example, a user may hover over or highlight a code segment resulting in a code development summary being presented in association with the selected code segment.

Although embodiments described above generally include a user or individual inputting or selecting (either expressly or implicitly) to initiate or view code development summaries, as described below, such initiation may occur in connection with a code development service, such as code development service 118, or other service (e.g., a search service, a software store service, a content generation service, or the like). For example, code development service 118 may initiate generation of code development summaries on a periodic basis. Such code development summaries can then be stored and, thereafter, accessed by the code development service 118 to provide to a user device for viewing (e.g., based on a user navigating to view a code development summary associated with particular code, or portion thereof).

The user device 110 can communicate with the code development summary manager 112 and/or code developing service 118 to initiate generation of a code development summary(s) and/or obtain a code development summary(s). In embodiments, for example, a user may utilize the user device 110 to initiate generation of code development summaries via the network 122. For instance, in some embodiments, the network 122 might be the Internet, and the user device 110 interacts with the code development summary manager 112 (e.g., directly or via another service such as the code developing service 118 or other service that provides code development summaries) to initiate generation of code development summaries. In other embodiments, for example, the network 122 might be an enterprise network associated with an organization. It should be apparent to those having skill in the relevant arts that any number of other implementation scenarios may be possible as well.

With continued reference to FIG. 1, the code development summary manager 112 can be implemented as server systems, program modules, virtual machines, components of a server or servers, networks, and the like. At a high level, the code development summary manager 112 manages generation of code development summaries in association with code. In particular, the code development summary manager 112 can obtain various code modification data, such as commit messages. Using the code modification data, the code development summary manager 112 generates a model prompt to initiate generation of a code development summary. As one example, a model prompt may include various commit messages associated with particular code or code segment. The model prompt can be input into an LLM to obtain, as output, a code development summary in association with code modification data provided in relation to particular code. Such code modification data used as a basis for generating a code development summary may be code modification data submitted via code developer devices 116. Code developer devices 116a-116n may be any type of computing devices at which a code developer (e.g., programmer, tester, or manager) may provide code modification data, such as commit messages, in association with particular code (e.g., for a software product, a computer application, a website, or other code for which a code development summary may be desired). For example, upon an individual providing a commit in association with code, the individual may provide a commit message indicating context for the commit (e.g., via the code developer device). The commit message provided via the code developer device may be provided to the code developing service 118 that facilitates collection and/or development of code.

In embodiments, the code development summary manager 112 preprocesses code modification data such that the code modification data included in the model prompt is more effective in generating a desired output. For example, various code modification data may be filtered out or removed based on date, developer providing the data, and/or the like.

In accordance with generating a code development summary, the code development summary manager 112 outputs the code development summary. In some cases, the code development summary manager 112 outputs a code development summary(s) to user device 110. For example, assume a user is viewing, or is interested in, particular code via application 120 operating on user device 110. In such a case, the code development summary associated with the particular code may be provided to the user device 110. In other cases, the code development summary manager 112 outputs a code development summary(s) to another service, such as code developing service 118, or a data store, such as data store 114. For example, upon generating a code development summary or set of code development summaries, the code development summary(s) can be provided to code developing service 118 and/or data store 114 for subsequent use. For instance, when a user subsequently views particular code, or indicates interest in particular code, via application 120 on user device 110, the code developing service 118 may provide code development summary to the user device.

The code developing service 118 may be any type of server or service that can facilitate code development. One example code developing service 118 includes an integrated development environment such as Visual Studio® Code, by Microsoft®, that can be used to develop computer programs, websites, web apps, web services, mobile apps, or the like. Code developing service 118 may communicate with applications operating on code developer devices 116 to provide back-end services to such applications. Further, in cases in which application 120 on user device 110 is a code developing application, such code developing service 118 may communicate with application 120 operating on user device 110 to provide back-end services to application 120.

As can be appreciated, in some cases, the code development summary manager 112 may be a part of, or integrated with, the code developing service 118. In this regard, the code development summary manager may function as portion of the code developing service 118. In other cases, the code development summary manager 112 may be independent of, and separate from, the code developing service 118. For example, the code development summary manager 112 may function as a portion of another service that can generate and/or provide code development summaries. By way of example, and not limitation, such services may include an application store, a search service, a content publication service, a marketing service, and/or the like. Any number of configurations may be used to implement aspects of embodiments described herein.

Advantageously, utilizing implementations described herein enable generation and presentation of code development summaries to be performed in an efficient manner. Further, the generated code development summaries can dynamically adapt to align with more recent code modifications provided by developers. As such, a user can view desired and up-to-date information about code modifications.

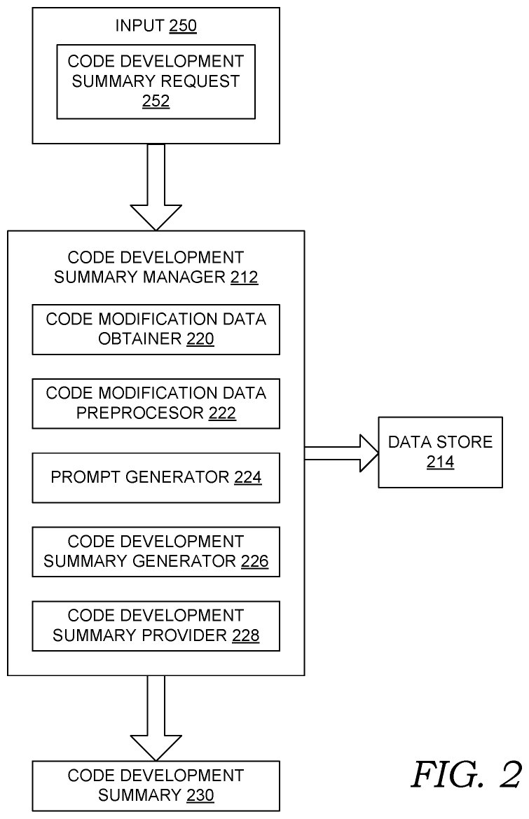

Turning now to FIG. 2, FIG. 2 illustrates an example implementation for generating and/or providing code development summaries, via code development summary manager 212. The code development summary manager 212 can communicate with the data store 214. The data store 214 is configured to store various types of information accessible by the code development summary manager 212 or other service, server, or device. In embodiments, user devices (such as user devices 110 of FIG. 1), code developer devices (such as code developer devices 116 of FIG. 1), code developing service (such as code developing service 118 of FIG. 1), and/or servers or services can provide data to the data store 214 for storage, which may be retrieved or referenced by any such component. As such, the data store 214 may store code, code modification data, and/or the like. In addition, data store 214 may store generated code development summaries, which can then be accessed for subsequent use or display.

In operation, the code development summary manager 212 is generally configured to manage generation and/or provision of code development summaries. In embodiments, the code development summary manager 212 includes a code modification data obtainer 220, a code modification data preprocessor 222, a prompt generator 224, a code development summary generator 226, and a code development summary provider 228. According to embodiments described herein, the code development summary manager 212 can include any number of other components not illustrated. In some embodiments, one or more of the illustrated components 220, 222, 224, 226, and 228 can be integrated into a single component or can be divided into a number of different components. Components 220, 222, 224, 226, and 228 can be implemented on any number of machines and can be integrated, as desired, with any number of other functionalities or services.

The code development summary manager 212 may receive input 250 to initiate generation and/or provision of a code development summary(s). Input 250 may include a code development summary request 252. A code development summary request 252 generally includes a request or indication to generate a code development summary. A code development summary request may specify, for example, an indication of code or a code portion for which a code development summary is desired, an indication of a set of code modification data (e.g., commit messages) for which a code development summary is desired, an indication of the user to which the code development summary is to be presented, and/or the like.

A code development summary request 252 may be provided by any service or device. For example, in some cases, a code development summary request 252 may be initiated and communicated via a user device, such as user device 110 of FIG. 1. For example, assume a user accesses a code developing application used to develop various codes (e.g., presented via the website or application). In such a case, a code development summary request 252 may be initiated that includes a request to generate code development summaries for the various codes. For instance, in one example, the code development summary request 252 may specify each code being developed via a code developing service. In another example, the code development summary request 252 may specify particular code(s) for which a code development summary is desired, such as code associated with software or products initially presented via the application or website, or a code selected or otherwise identified in association with a user interest (e.g., a user pauses scrolling over a code identifier, selecting the code or a code segment, and/or the like). In another example, a user may be an individual or entity associated with a code or software product having code (e.g., a developer, tester, manager, marketer, or provider of the code or product). In such a case, the user may select to view a code development summary associated with the particular code such that the user can obtain code development summary related to the code. In this way, the user may view the code development summary to identify modifications made to the code (e.g., within a certain time frame, associated with a particular version or release, or the like). In yet another example, a user may be an individual or entity interested in a code or software product, such as a consumer or potential consumer of a code or software product. In this regard, a code development summary request 252 may be initiated that includes a request to generate a code development summary associated with a product being searched for (e.g., via a search service) or considered for downloading or installing (e.g., an application service).

Alternatively or additionally, a code development summary request 252 may be automatically initiated and communicated via a service, such as code developing service 118 or other service (e.g., search service, marketing service, or the like). For example, a code developing service, such as code developing service 118, associated with code development may automatically initiate generation of code development summaries, for instance, based on a lapse of a time period, a new commit or release of code, obtaining a threshold number of new code modification data (e.g., commit messages), or other criteria. As another example, an application service that provides applications for downloading or installing may automatically initiate generation of code development summaries, for instance, based on a release of a new product, a new product version, or the like. As can be appreciated, the automated initiation of a code development summary generation may be dynamic, for instance, based on attributes associated with the item. For example, in cases in which code modification data are more frequently provided, a code development summary request may be initiated more frequently, whereas when code modification data for code are less frequently provided by developers, the code development summary request for an item may be initiated less frequently.

Although not illustrated, input 250 may include other information communicated in association with a code development summary request 252. For example, and as described below as one implementation, code modification data (e.g., commit messages), an indication of code modification data (e.g., a start commit message, an end commit message, a commit message range, or the like), user data (e.g., associated with a user viewing a code development summary), code modification data weights, or the like, may be provided in association with the code development summary request. For instance, in some cases, a user (e.g., a code development manager) may provide an indication of start commit message and an end commit message for use in generating a code development summary, which is communicated in association with a code development summary request to initiate generation of a code development summary.

The code modification data obtainer 220 is generally configured to obtain code modification data. In this regard, in some cases, the code modification data obtainer 220 obtains code modification data in accordance with obtaining a code development summary request, such as code development summary request 252. Code modification data generally refers to any data associated with a code modification and/or used to generate a code development summary.

In embodiments, code modification data includes commit message data associated with code or a code segment. Commit message data generally refers to any data associated with a commit. By way of example only, commit message data may include a commit message, a commit identifier (e.g., uniquely identifying a commit), a commit author (e.g., identifying an author, creator or initiator of a commit or commit message), a commit date (e.g., a date and/or time of a commit or commit message), and/or the like. As described, a commit message generally refers to a message related to a commit operation. A commit operation can send the latest changes of source code to a repository (e.g., local repository), thereby making the changes part of a head or master revision of the repository. A commit message may include various types of data, such as a type of commit, a scope of commit, a subject, a body indicating or explaining changes made and reasons for the change, a footer indicating issues affected by the code changes or comments to another developer, or the like. The code modification data obtainer 220 may use any type of information or a particular type(s) of information associated with a commit message. For example, in some cases, text in the body of the commit message indicating a brief overview or summary of the commit change may be obtained.

In embodiments, commit message data includes data identified in association with a commit or commit message. For example, in some cases, a commit message may include a reference to a pull request identifier (e.g., “pull request xyz was merged”). In such a case, upon recognizing a pull request identifier, data associated with the pull request may be obtained, for example, by the code modification data obtainer 220. For example, the code modification data obtainer 220, or other component, can connect to another system (e.g., Azure DevOps services) to identify any information associated with the specified pull request. A pull request is generally used to provide or merge commits to a main branch from which multiple developers may be working from.

In addition to obtaining commit message data, the code modification data obtainer 220 may obtain other types of code modification data. As described, code modification data generally refers to any data associated with a code modification and/or used to generate a code development summary. Other types of code modification data include, for example, tasks, bug reports, pull requests, among other things. As such, the code modification data obtainer 220 may be obtain other types of code modification data in addition to or instead of commit message data.

Further, the code modification data obtainer 220 may obtain other types of data, such as user data, developer data, code modification data weights, and/or the like. User data generally refers to any data associated with a user, for example, that initiated, and/or may view, a code development summary. For instance, user data may include demographics associated with the user, user preferences, and/or the like (e.g., via a user profile). Developer data generally refers to any data associated with a developer of particular code. For example, for a developer that provided a commit message associated with code, developer data may include a developer identifier, demographic data associated with the developer, preferences associated with the developer, and/or the like. Code modification data weights generally refer to weights, ranks, or scales associated with code modification data, such as commit messages. Code modification data, such as commit message data, may be weighted based on any number of attributes including, for example, recency of commit message, length of commit message, creator of commit message, or the like.

The code modification data obtainer 220 can receive or obtain code modification data from various sources for utilization in determining code development summaries. As described above, in some cases, code modification data may be obtained as input 250 along with the code development summary request 252. For example, in some implementations, a user (e.g., a developer or manager of code) may input or select code modification data, or a portion thereof, via a graphical user interface for use in generating code development summaries. For instance, a user, operating via a user device, desiring to review a code development summary for a particular code segment may select or input a set of commit messages associated with code or a code portion for use in generating corresponding code development summaries. In particular, a user may specify a start commit message and/or end commit message for use in generating a code development summary.

Additionally or alternatively, the code modification data obtainer 220 may obtain code modification data from any number of sources or data stores, such as data store 214. In this regard, in accordance with initiating generation of a code development summary, the code modification data obtainer 220 may communicate with a data store(s) or other data source(s), including a code developing service (e.g., code developing service 118 of FIG. 1) and obtain code modification data to generate a code development summary(s). Such code modification data that may be obtained includes, for example, commit message data, user data, developer data, code modification data weights, and/or the like. Data store 214 illustrated in FIG. 2 may include such code modification data, but any number of data stores and/or data sources may provide various types of code modification data. Such data stores and data sources may include public data, private data, and/or the like. For instance, a code developing service may store data associated with various items, including commit messages associated with code.

In some cases, code modification data (e.g., commit messages) is identified via a local data source (e.g., a local repository). For example, upon obtaining an indication of commit messages, code modification data associated with the commit messages may be accessed or obtained via a data source local to a requesting user device. One example of such a data source includes Git® software and/or Git® repository. Git® includes software to track changes to sets of files during software development. A Git® repository can include a set of commit objects and a set of references to commit objects. The Git® repository may be stored in a same directory as the project itself. A commit object may include a set of files reflecting the state of the project at a point in time, references to parent commit objects, and a unique identifier of the commit object. Other types of information may additionally or alternatively be identified in association with a local Git® repository. In other cases, code modification data is identified via a global data source. For example, a global repository, such as a GitHub® repository, can be accessed and used to obtain code modification data. For example, an API specific to the global repository (e.g., GitHub® repository) can be used to obtain code modification data. As can be appreciated, any version control tool and/or repository manager tool could be used in accordance with embodiments described herein, and the examples provided herein are not intended to be limiting.

In some cases, the code modification data obtainer 220 may identify a type or extent of code modification data to obtain. For example, assume a code development summary request 252 corresponds with an indication of code or set of codes. For instance, a code developing service associated with a set of codes may provide a code development summary request indicating each code or a portion of the codes (e.g., via code identifiers). Upon identifying the code, the code modification data obtainer 220 may obtain commit messages associated with the specified code (e.g., by accessing data associated with the code via a data store). As another example, assume a code development summary request 252 is provided upon a user accessing an application store. In such a case, the code modification data obtainer 220 may obtain user data associated with the particular user accessing the application store. In some cases, the code modification data obtainer 220 may obtain code modification data associated with particular code identified in association with the user accessing the application store (e.g., a user selection of the particular product, a user hovering over the particular product, or a user search of the particular product). As yet another example, assume a code development summary request 252 includes a code segment indicator specifying a particular segment of code (e.g., lines of code), code modification data associated with the specified code segment may be identified. As yet another example, assume a code development summary request 252 includes a developer indicator associated with particular code or a particular segment of code, code modification data (e.g., commit messages) associated with the developer may be identified. Such developer specific code modification data may be limited to data associated with the specific code or code segment, but need not be the case. For example, any code modification data associated with the developer (e.g., during a certain timeframe) may be identified (e.g., across different sets of code and/or code segments).

In some embodiments, particular code modification data to obtain by the code modification data obtainer 220 may be based on a set of commits or commit messages. In this way, a set of commits or commit messages may be specified or selected and, thereafter, used for obtaining the corresponding commit messages. For example, a code development summary request may include an indication of a set of commits or commit messages. In this regard, a user may specify or select a set of commits or commit messages (e.g., via a user interface), which can then be used to obtain corresponding commit messages. Commit messages can be indicated in any number of ways. In some cases, commit message identifiers may be used to specify a set of commit messages or range of commit messages. For example, a start commit message and an end commit message can be identified to specify a range of commit messages to obtain and analyze. In other cases, commit identifiers may be used to specify a set of commit messages or range of commit messages associated with the specified commit identifiers. For example, a start commit and end commit may be specified or input and, based on the start and end commit identifiers, commit messages associated therewith can be obtained. As can be appreciated, a start/end commit and/or a start/end commit message can be specified via a graphical user interface. For instance, a user may input a command or a query in natural language to specify a start/end commit or commit message. As another example, a list of commits or commit messages may be displayed from which a user can select a start and/or end commit or commit message. In other cases, a start/end commit may be automatically determined. For instance, assume a user specifies use of commit data associated with a particular release. In such a case, commits can be identified in association with the particular release and corresponding commit messages can be obtained. In embodiments, commits are linear and, as such, reference or link to one another. As such, obtaining each of the commits and/or corresponding commit messages between a start and end commit or commit message can be efficiently performed.

The particular type of data obtained by the code modification data obtainer 220 may vary depending on the particular configuration implemented. For example, in some cases, in accordance with obtaining commit messages, a set of corresponding weights may also be obtained. In some embodiments, weights may be determined using a machine learning model. For example, in some cases, a large language model (e.g., an LLM associated with the code development summary generator 226) may be used to generate weights. In this regard, a prompt may be generated with an instruction to generate weights for a set of commit messages. The prompt can be input into the LLM to generate weights for the set of commit messages. In this regard, an iterative process is performed in that an LLM is initially used to generate weights for a set of commit messages (e.g., via a prompt instructing to generate weights) and, thereafter, the LLM is used to generate a code development summary for the set of commit messages in accordance with the weights (e.g., via a prompt instructing to generate a code development summary).

In other cases, weights may be subsequently determined (e.g., via the code modification data preprocessor 222) and, as such, are not obtained via the code modification data obtainer 220. As another example, in some cases, user data and developer data (or other types of data) is not used in generating a code development summary and, as such, is not obtained by the code modification data obtainer 220. The examples of types of data obtained by the code modification data obtainer 220 are not intended to be restrictive. In this regard, the code modification data obtainer 220 may obtain more or less, or different, types of code modification data.

The code modification data obtainer 220 may also obtain any amount of code modification data. For example, in some cases, each commit message associated with particular code may be obtained. In other cases, only a portion of the commit messages associated with particular code may be obtained. For instance, commit messages associated with a particular code portion or associated with a particular time range may be obtained. By way of further example, commit messages associated with a particular code release may be obtained. The type and amount of code modification data obtained by code modification data obtainer 220 may vary per implementation and is not intended to limit the scope of embodiments described herein.

As can be appreciated, in addition or in the alternative to identifying a type or amount of code modification data to obtain based on input (e.g., user input or selection), such data can be automatically identified. As one example, in accordance with a release of a new version of a product, commit messages composed since the previous version of the product can be automatically identified and obtained as code modification data for use in generating a code modification summary. As another example, assume a user viewed a previously generated code development summary. Based on identifying the user and the viewing date of the previously generated code development summary, code modification data generated subsequent to the previous viewing data may be identified and used for generating a new code development summary.

The code modification data obtainer 220 can employ any type of technology to obtain code modification data. By way of example only, the code modification data obtainer 220 may use various types of technology to extract commit message data (e.g., metadata that accompanies a commit) in association with commits and/or code. In this way, upon accessing or obtaining code, or a portion thereof, the code modification data obtainer 220 can extract commit messages in association therewith, as appropriate. Commit message data, such as commit messages, can be extracted, for example, using a particular command.

The code modification data preprocessor 222 is generally configured to preprocess code modification data, or a portion thereof. The code modification data preprocessor 222 may preprocess code modification data in any number of ways to effectuate a more efficient and effective code development summary prompt. As described herein, a model prompt is generated to initiate generation of a code development summary. As such, the code modification data preprocessor 222 may preprocess various code modification data to optimize the code modification data included in a model prompt. To this end, the more intentional or targeted the code modification data included in the model prompt, the more effective and efficient a code development summary is generated.

In one embodiment, the code modification data preprocessor 222 preprocesses code modification data by removing or filtering data. In this regard, the code modification data preprocessor 222 can filter out or remove particular code modification data (e.g., commit messages). As one example, the code modification data preprocessor 222 may filter out code modification data associated with a particular time duration (e.g., more than one week old). As another example, the code modification data processor 222 may filter out code modification data provided by a particular developer or set of developers, commit messages over a certain length, and/or the like. Filtering of data, such as commit messages, may depend on the target or intent of the code development summary. For instance, in cases in which a summary is desired for a particular time frame (e.g., since a last product release), removing code modification data outside of that time frame may be employed. As another example, in cases in which a summary is desired in association with a particular developer or team of developers, code modification data corresponding with other developers can be removed.

Another example of filtering content modification data may include filtering content modification data having negative content or language, such as profanity or other inappropriate language. In this way, the code modification data preprocessor 222 may identify negative content or language and remove content modification data having the negative content. Any technology may be used to identify such negative content, including, for example, machine learning technology.

As another example, content modification data may be filtered to remove redundant data. For instance, assume two different commit messages include a same or similar description of a change made to the code. In such a case, one of the commit messages can be excluded or removed, such that duplicative information is not provided in the model prompt for generating a code development summary.

In some cases, rather than removing a code modification data (e.g., a commit message) in its entirety, the code modification data may be edited or modified as desired. For example, sentences including negative language may be removed or modified.

Additionally or alternatively, the code modification data preprocessor 222 may modify or update code modification data based on user input. For example, a user may tailor or modify commit message content for use in generating a code development summary. In other cases, a user may remove specific commit messages that are undesired for use in generating a code development summary.

In some embodiments, the code modification data preprocessor 222 may generate weights for code modification data. Weights may be generated for use by code development summary generator 226 to generate a code development summary. To this end, a weight provides an indication of focus of code modification data for generating output. A weight may be in any number of forms, including a numerical weight. The code modification data preprocessor 222 may generate a weight based on any number or type of data. As one example, a weight may be generated in association with a date or recency of the code modification data (e.g., more recently dated commit messages are assigned a higher weight). As another example, a weight may be generated in association with a developer or creator of the code modification data. Other aspects may be additionally or alternatively used by the code modification data preprocessor 222 to generate a weight.

Filtering and weighting code modification data are only examples of different data preprocessing that the code modification data preprocessor 222 may perform. As can be appreciated, various other types of data preprocessing are contemplated within the scope of embodiments described herein.

The prompt generator 224 is generally configured to generate model prompts. As used herein, a model prompt generally refers to an input, such as a text input, that can be provided to code development summary generator 226, such as an LLM, to generate an output in the form of a code development summary(s). In embodiments, a model prompt generally includes text to influence a machine learning model, such as an LLM, to generate text having a desired content and structure. The model prompt typically includes text given to a machine learning model to be completed. In this regard, a model prompt generally includes instructions and, in some cases, examples of desired output. A model prompt may include any type of information. In accordance with embodiments described herein, a model prompt may include various types of content modification data. In particular, a model prompt generally includes commit message data (e.g., commit messages), or portions thereof, associated with code. Such content modification data may be preprocessed via code modification data preprocessor 222, as described herein. For example, in some cases, content modification data may be filtered out of a set of candidate content modification data based on a negative language, time associated with the data, and/or the like.

In embodiments, the prompt generator 224 is configured to select a set of code modification data for which to use to generate code development summaries. For example, assume a code development summary is to be generated for particular code and each of the commit messages associated with the particular code are obtained. In such a case, the code modification data preprocessor 222 may select a set of commit messages to provide for generating the code development summary. In this way, after various commit messages are filtered or updated to remove unwanted data, the prompt generator 224 may select a set of commit messages from the remaining commit messages.

Code modification data may be selected based on any number or type of criteria. As one example, code modification data may be selected to be under a maximum number of tokens required by a code development summary generator, such as an LLM. For example, assume an LLM includes a 3000 token limit. In such a case, code modification data totaling less than the 3000 token limit may be selected. Such code modification data selection may be based on, for example, recency of the code modification data such that more recent code modification data are selected. In other cases, code modification data may be selected to correspond with a recent version of a product or code. In yet other cases, code modification data may be selected based on weights (e.g., highest weights, equal distribution of weights, or other criteria associated with a weight). For instance, a code modification data may be selected based on a corresponding weight that is an indication of the helpfulness of the code modification data.

In embodiments, code modification data in the model prompt includes commit messages, or data associated therewith. For example, text from a set of commit messages associated with particular code can be included in the model prompt. In addition to the model prompt including commit message data, additional code modification data may be included, such as, for example, user data, developer data, and weights. As described, weights associated with corresponding code modification data can be provided in the model prompt to indicate an emphasis or focus to place on corresponding code modification data in generating a code development summary. As such, in accordance with including commit message data in a model prompt, the corresponding weights can also be included. Other types of information to include in a model prompt, such as user data, developer data, and/or the like, can additionally or alternatively be included in the model prompt, depending on the desired implementation or output.

In addition to including code modification data, a model prompt may also include an instruction and/or output attributes. An instruction generally refers to the instruction, command, or query used to request the code development summary (e.g., generate a code development summary using the below code modification data). In some cases, the instruction may specify a target audience or a desired type of content. For example, the instruction may specify for test manager, need test notes, or for a release manager, need release notes. As another example, an instruction may include a request to include an indication of or reference to the corresponding commits, commit messages, pull requests, and/or the like (e.g., via markdown). For instance, the instruction may include a request to provide links to pull requests associated with the commits from which the code development summary was generated.

Output attributes generally indicate desired aspects associated with an output, such as a code development summary. For example, an output attribute may indicate a target type of output, such as a target audience for the summary (e.g., a manager of product development, a test coordinator, a release manager, a product marketer, an individual interested in purchasing or downloading a product). Providing an audience type can facilitate generation of a code development summary that is more in line with the desires or interests of the audience type. In some cases, the audience type can be automatically identified based on the user initiating (e.g., either directly or indirectly) generation of a code development summary. In other cases, an audience type can be provided as input, such as via a code development summary request. As another example, an output attribute may indicate a format or content for output, such as a bullet point list, indications of new features, indications of feature changes, a blog format, a technical release note, and/or the like. As another example, an output attribute may indicate a length of output. For example, a model prompt may include an instruction for a desired one paragraph or three paragraphs. As another example, an output attribute may indicate a target language for generating the output. For example, the code modification data may be provided in one language (or a variety of languages), and an output attribute may indicate to generate the output in another language (or a single language). As yet another example, a temperature parameter specifying a desired level of randomness and creativity in the generated text may be provided. For example, for potential consumers, more creativity may be desired in a blog write up, as opposed to a more factual text that may be desired for a program manager. Any other instructions indicating a desired output are contemplated within embodiments of the present technology.

The prompt generator 224 may format the code modification data and output attributes in a particular form or data structure. One example of a data structure for a model prompt is as follows:

```
{ Instruction to Generate a Code Development Summary
{ Context Modification Data
  { Commit Message 1
    .
    .
    .
  { Commit Message N
{ Output Attributes
  {Target Audience
  {Target Style (e.g., blog format, bullet-point list)
```

As described, in embodiments, the prompt generator 224 generates or configures model prompts in accordance with size constraints associated with a machine learning model. As such, the prompt generator 224 may be configured to detect the input size constraint of a model, such as an LLM or other machine learning model. Various models are constrained on a data input size they can ingest or process due to computational expenses associated with processing those inputs. For example, a maximum input size of 14096 tokens (for davinci models) can be programmatically set. Other input sizes may not necessarily be based on token sequence length, but other data size parameters, such as bytes. Tokens are pieces of words, individual sets of letters within words, spaces between words, and/or other natural language symbols or characters (e.g., %, $, !). Before a language model processes a natural language input, the input is broken down into tokens. These tokens are not typically parsed exactly where words start or end—tokens can include trailing spaces and even sub-words. Depending on the model used, in some embodiments, models can process up to 4097 tokens shared between prompt and completion. Some models (e.g., GPT-3) take the input, convert the input into a list of tokens, process the tokens, and convert the predicted tokens back to the words in the input. In some embodiments, the prompt generator 224 detects an input size constraint by simply implementing a function that calls a routine that reads the input constraints.

The prompt generator 224 can determine which data, for example, obtained by the code modification data obtainer 220, preprocessed by the code modification data preprocessor, or the like is to be included in the model prompt. In some embodiments, the prompt generator 224 takes as input the input size constraint and the code modification data to determine what and how much data to include in the model prompt. By way of example only, assume a model prompt is being generated in relation to particular code or a particular code segment. Based on the input size constraint, the prompt generator 224 can select which data, such as commit messages, to include in the model prompt. As described, such a data selection may be based on any of a variety of aspects, such as data of code modification data, weights of code modification data, and/or the like. As one example, the prompt generator 224 can first call for the input size constraint of tokens. Responsively, the prompt generator 224 can then tokenize each of the code modification data (e.g., commit messages) candidates to generate tokens and, thereafter, responsively and progressively add each data set ranked/weighted from highest to lowest if and until the token threshold (indicating the input size constraint) is met or exceeded, at which point the prompt generator 224 stops.

The prompt generator 224 may generate any number of model prompts. As one example, an individual model prompt may be generated for particular code or a particular code segment. In this way, a one-to-one model prompt may be generated for a corresponding code or code segment. As another example, a particular model prompt may be generated to initiate code development summaries for multiple codes or code segments. For instance, a model prompt may be generated to include an indication of a first code and corresponding commit messages, a second code and corresponding commit messages, and so on.

The code development summary generator 226 is generally configured to generate code development summaries. In this regard, the code development summary generator 226 utilizes various code modification data, such as commit messages, to generate a code development summary associated with particular code, or portion thereof. In embodiments, the code development summary generator 226 can take, as input, a model prompt or set of model prompts generated by the prompt generator 224. Based on the model prompt, the code development summary generator 226 can generate a code development summary or set of code development summaries associated with a commit message(s) indicated in the model prompt. For example, assume a model prompt includes a set of commit messages associated with a particular code segment. In such a case, the code development summary generator 226 generates a code development summary associated with the particular code segment based on the set of commit messages included in the model prompt.

Advantageously, as the code development summary is generated based on code modification data associated with code, the code development summary is generally generated using language that provides an indication of first-hand knowledge of modifications associated with the code. As such, the code development summary can provide an accurate summary of modifications associated with code to potential consumers and/or individuals associated with code development (e.g., managers). Further, the code development summary is generated in accordance with desired output attributes, thereby efficiently generating an effective code development summary.

The code development summary generator 226 may be or include any number of machine learning models or technologies. In some embodiments, the machine learning model is an LLM. A language model is a statistical and probabilistic tool which determines the probability of a given sequence of words occurring in a sentence (e.g., via next sentence prediction (NSP) or masked language model (MLM)). Simply put, it is a tool which is trained to predict the next word in a sentence. A language model is called a large language model when it is trained on enormous amount of data. In particular, a LLM refers to a language model including a neural network with an extensive amount of parameters that is trained on an extensive quantity of unlabeled text using self-supervising learning. Oftentimes, LLMs have a parameter count in the billions, or higher. Some examples of LLMs are GOOGLE's BERT and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM performs automatic summarization (or text summarization). Such automatic summarization includes the process of NLP text summarization, which is the process of breaking down text (e.g., several paragraphs) into smaller text (e.g., one sentence or paragraph). This method extracts vital information while also preserving the meaning of the text. This reduces the time required for grasping lengthy text content without losing vital information. An LLM can also perform machine translation, which includes the process of using machine learning to automatically translate text from one language to another without human involvement. Modern machine translation goes beyond simple word-to-word translation to communicate the full meaning of the original language text in the target language. It analyzes all text elements and recognizes how the words influence one another. Although some examples provided herein include a single-mode generative model, other models, such as multi-modal generative models, are contemplated within the scope of embodiments described herein. Generally, multi-modal models are generated to make predictions based on different types of modalities (e.g., text and images).

As such, as described herein, the code development summary generator 226, in the form of an LLM, can obtain the model prompt and, using such information in the model prompt, generate a code development summary for code or a code segment. In some embodiments, the code development summary generator 226 takes on the form of an LLM, but various other machine learning models can additional or alternatively be used.

The code development summary can be generated in any number of forms, and in some cases, in accordance with instructions included in the model prompt. As one example, a code development summary may include text written in the form of a blog or other natural language description. As another example, a code development summary may include a bullet-point list or a table. Further, the particular content can be tailored to the audience intended to view the code development summary. For instance, a code development manager may be presented with a code development summary including one description or content (e.g., a more factual description), while a potential consumer of a product may be presented with a code development summary including another description or content (e.g., a more creative, enthusiastic, persuasive, or positive description).

The code development summary provider 228 is generally configured to provide code development summaries. In this regard, upon generating a code development summary(s), the code development summary provider 228 can provide such data, for example for display via a user device. To this end, in cases in which the code development summary manager 212 is remote from the user device, the code development summary provider 228 may provide a code development summary(s) to a user device for display to a user that initiated the request for viewing a code development summary(s). In embodiments, the code development summary is generated and provided for display in real time. In this way, in response to an indication to generate a code development summary (e.g., directly or indirectly initiating a code development summary by interacting with an application or website associated with code, or a corresponding software product), a code development summary is generated and provided to the user in real time. In some cases, to the extent the user views the code, or data associated therewith, at a later time, the code development summary can be updated in real time by performing generation or updating of the code development summary (e.g., based on more recent code modification data) and providing the updated code development summary in real time for viewing. In this way, at a first time of viewing information associated with code, a user may view one version of a code development summary associated with the code, and at a second subsequent time of viewing the code, the user may view another, more updated, version of a code development summary.

Alternatively or additionally, the code development summary may be provided to a data store for storage or another component or service, such as a code developing service (e.g., code developing service 118 of FIG. 1). Such a component or service may then provide the code development summary for display, for example, via a user device. For instance, as described herein, in some cases, code development summaries may be generated in a periodic manner. As one example, code development summaries may be generated for a set of codes in off-hours (hours in which computing resources are more available and not used by other processes). Such code development summaries can then be stored, for example in data store 214. Thereafter, assume a user navigates, via a user device, to an application providing various code development functionalities. In association with navigating to the application, or particular code associated therewith, a code developing service can access an appropriate code development summary (e.g., corresponding with the particular code) and provide the code development summary for display. Similarly, as another example, assume a user navigates to an application or website that provides information associated with code or product releases. In such a case, a content, marketing, or search service can access an appropriate code development summary associated with a particular product and provide the summary for display.

The code development summary may be provided for display in any number of ways. In some examples, the code development summary is provided in association with the corresponding code. In other examples, a code development summary is provided in association with a presentation of a product (e.g., a listing of a product and corresponding code development summary). In yet other examples, a code development summary is provided as a blog post or article associated with a product having the corresponding code. In some cases, the code development summary is automatically displayed in association with the code or corresponding product. In other cases, a user may select to view the code development summary. For instance, a link may be presented that, if selected, presents the code development summary (e.g., integrated with the product description or details, or provided in a separate window or pop-up text box).

As such, a code development summary 230 can be provided as output from the code development summary manager 212. As described, the code development summary 230 may be provided to a user device for real time display. Alternatively or additionally, the code development summary data 230 can be provided to the data store 214 and/or other service or system (e.g., code developing service).

As can be appreciated, the process can be implemented in an iterative manner. For example, upon viewing a code development summary 230, the initial model prompt can be modified to obtain a more desirable output. For instance, a particular format may be specified that is different than the initially provided format that may be requested in an updated model prompt.

### Exemplary Implementations for Efficiently Generating Code Development Summaries

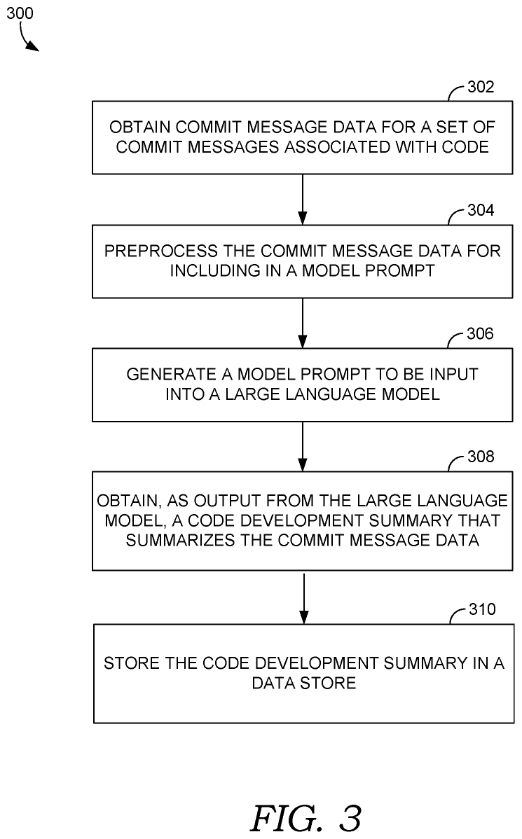

As described, various implementations can be used in accordance with embodiments described herein. FIGS. 3-5 provide methods of facilitating efficient generation of code development summaries. Methods 300, 400, and 500 can be performed by a computer device, such as device 600 described below. The flow diagrams represented in FIGS. 3-5 are intended to be exemplary in nature and not limiting.

Turning initially to method 300 of FIG. 3, method 300 is directed to facilitating efficient generation of code development summaries, in accordance with embodiments of the present technology. Initially, at block 302, commit message data for a set of commit messages associated with code is obtained. Each commit message comprises a description associated with a corresponding modification in the code. In some cases, the set of commit messages includes commit messages associated with a start commit through an end commit. For example, a user select, via a graphical user interface, a start commit and an end commit. Based on the selected start and end commits, commit messages associated with such commits and therebetween are automatically identified and commit message data associated therewith is obtained. In some cases, a start commit corresponds with a start of a new release of code, and an end commit corresponds with an end of the new release of code. In one implementation, obtaining commit message data includes analyzing the commit messages to recognize any pull request identifier, or other link or reference, from which additional data can be obtained. As one example, a pull request identifier in a commit message can be identified and used to obtain information associated with the pull request identifier. Such information can then be included in the commit message data.

At block 304, the commit message data is preprocessed for including in a model prompt. In some cases, such preprocessing includes removing or filtering undesired commit message data. For example, duplicative data or negative data may be identified and removed from the commit message data used to generate the model prompt.

At block 306, a model prompt to be input into a large language model is generated. The model prompt includes at least a portion of the commit message data. In embodiments, the portion of message data included in the model prompt may be determined in accordance with an input prompt size constraint associated with the large language model. In addition to including commit message data in the model prompt, the model prompt may include additional data, such as an indication of a type of audience for which the code development summary is to be generated. Indicating the type of audience can facilitate the content generated for the code development summary. For example, a program developer may be provided with different content than a potential consumer of a product.

At block 308, a code development summary that summarizes the at least the portion of the commit message data for the set of commit messages associated with the code is obtained as output from the large language model. The code development summary may be in any number of forms, such as a blog format, a listing format, and/or the like. In embodiments, the code development summary includes a link to a pull request associated with the commit message data.

At block 310, the code development summary is stored in a data store. The code development summary can additionally or alternatively be presented for display. For example, in response to a request for viewing the code development summary, the code development summary, or a portion thereof, can be provided for display.

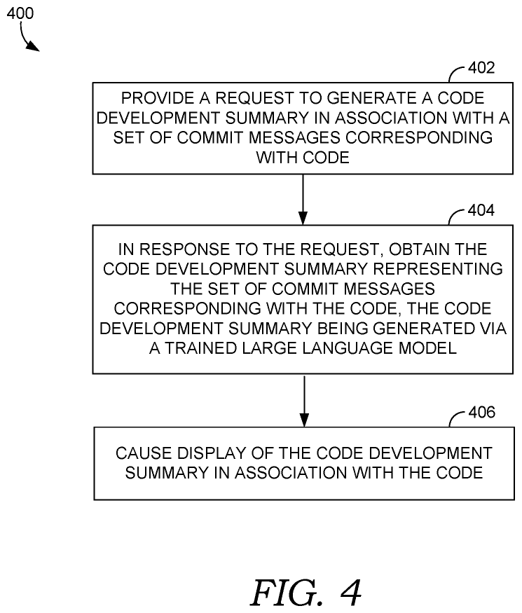

Turning now to FIG. 4, FIG. 4 includes another method 400 for facilitating efficient generation of code development summaries, in accordance with embodiments of the present technology. Initially, at block 402, a request to generate a code development summary in association with a set of commit messages corresponding with code is provided. In some cases, the request is automatically provided. For example, based on a new commit associated with the code, the request is automatically generated. As another example, in response to a user selection of the set of commit messages, or commits associated therewith, the request is automatically generated. At block 404, in response to the request, obtaining the code development summary representing the set of commit messages corresponding with the code, the code development summary being generated via a trained large language model. In some embodiments, a model prompt is generated that includes the set of commit messages corresponding with the code and, thereafter, inputted into the trained LLM to generate the code development summary. At block 406, the code development summary in association with the code is display. The code development summary can be presented in association with an indication of the code. The code development summary can be generated in any number of formats. In some cases, the format used for the code development summary may be based on input included in a model prompt. In other cases, the format used for the code development summary may be based on a target audience to view the code development summary.

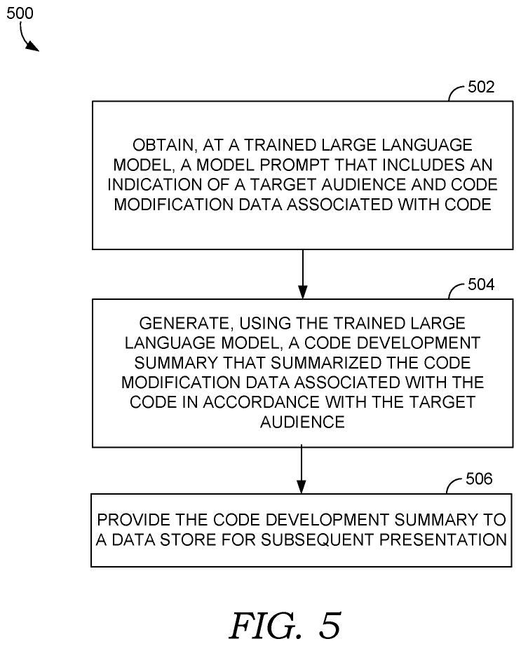

Turning now to FIG. 5, FIG. 5 provides another method 500 for facilitating efficient generation of code development summaries, in accordance with embodiments of the present technology. At block 502, a model prompt that includes an indication of a target audience and code modification data associated with code is obtained at a trained large language model. In embodiments, the code modification data comprises a description associated with a corresponding modification in the code. In some cases, a target audience can be a particular consumer audience. For example, a target audience may be a consumer or potential consumer of a product that is geographically located in a certain area or included within a certain demographic. In other cases, a target audience can be a particular code developer audience. For example, a target audience may be identified by a name or user identifier, a position (e.g., a product manager, a tester, a marketer), and/or the like. The target audience may be specified or automatically determined (e.g., based on a user desiring to view the code development summary). The model prompt may include various other types of data, such as output attributes that indicate a desired format or style for the code development summary. At block 504, a code development summary that summarizes the code modification data associated with the code in accordance with the target audience is generated using the trained large language model. Thereafter, at block 506, the code development summary is provided to a data store for subsequent presentation. In some cases, the code development summary is alternatively or additionally provided for display. By way of example only, a user may request to view the code development summary, for instance, while engaging with the code or for use in determining whether to install or use the code.

Accordingly, we have described various aspects of technology directed to systems, methods, and graphical user interfaces for intelligently generating and providing code development summaries. It is understood that various features, sub-combinations, and modifications of the embodiments described herein are of utility and may be employed in other embodiments without reference to other features or sub-combinations. Moreover, the order and sequences of steps shown in the example methods 300, 400, and 500 are not meant to limit the scope of the present disclosure in any way, and in fact, the steps may occur in a variety of different sequences within embodiments herein. Such variations and combinations thereof are also contemplated to be within the scope of embodiments of this disclosure.

In some embodiments, a computerized system, such as the computerized system described in any of the embodiments above, comprises one or more processors, and one or more computer storage media storing computer-useable instructions that, when executed by the one or more processors, cause the one or more processors to perform operations. The operations comprise obtaining commit message data for a set of commit messages associated with code, wherein each commit message comprises a description associated with a corresponding modification in the code. The operations further include generating a model prompt to be input into a large language model, the model prompt including at least a portion of the commit message data. The operations further include obtaining, as output from the large language model, a code development summary that summarizes the at least the portion of the commit message data for the set of commit messages associated with the code. In this way, embodiments, as described herein, enable efficient generation of code development summaries via use of a trained machine learning model, such as a large language model, without requiring fine-tuning of the model. Further, in this way, embodiments, as described herein, cause certain code development summaries associated with code to be programmatically surfaced and presented without requiring computer tools and resources for an individual to manually perform operations to produce this outcome.

In any combination of the above embodiments of the computerized system, the set of commit messages comprises commit messages corresponding with a start commit through an end commit associated with the code.

In any combination of the above embodiments of the computerized system, the operations further comprise receiving a user selection of the start commit and the end commit.

In any combination of the above embodiments of the computerized system, the start commit corresponds with a start of a new release of the code, and the end commit corresponds with an end of the new release of the code.

In any combination of the above embodiments of the computerized system, the operations further comprise preprocessing the commit message data for including in the model prompt, wherein the preprocessing comprises removing or filtering undesired commit message data.

In any combination of the above embodiments of the computerized system, the at least the portion of the commit message data is determined in accordance with an input prompt size constraint associated with the large language model.

In any combination of the above embodiments of the computerized system, the model prompt includes an indication of a type of audience for which the code development summary is to be generated.

In any combination of the above embodiments of the computerized system, the operations further comprise storing the code development summary that summarizes the at least the portion of the commit message data; and in response to a request for the code development summary, providing at least a portion of the code development summary for display.

In any combination of the above embodiments of the computerized system, the operations further comprise identifying a pull request identifier in a commit message of the set of commit messages; obtaining information associated with the pull request identifier; and including the information associated with the pull request identifier in the commit message data.

In any combination of the above embodiments of the computerized system, the code development summary includes at least one link to a pull request associated with the at least the portion of the commit message data.

In other embodiments, a computer-implemented method is provided. The method includes providing a request to generate a code development summary in association with a set of commit messages corresponding with a code. The method also includes in response to the request, obtaining the code development summary representing the set of commit messages corresponding with the code, the code development summary being generated via a trained large language model. The method further includes causing display, via a graphical user interface, of the code development summary in association with the code. In this way, embodiments, as described herein, enable efficient generation of code development summaries via use of a trained machine learning model, such as a large language model, without requiring fine-tuning of the model. Further, in this way, embodiments, as described herein, cause certain code development summaries associated with code to be programmatically surfaced and presented without requiring computer tools and resources for an individual to manually perform operations to produce this outcome.

In any combination of the above embodiments of the computer-implemented method, the method may further include preprocessing a plurality of commit messages corresponding with the code to remove one or more commit messages; and selecting the set of commit messages from the preprocessed plurality of commit messages, wherein the set of commit messages are selected from the preprocessed plurality of commit messages based on at least one criteria associated with the commit messages.

In any combination of the above embodiments of the computer-implemented method, the request is automatically provided based on a new commit associated with the code.

In any combination of the above embodiments of the computer-implemented method, the request is automatically provided in response to a user selection, via the graphical user interface, of the set of commit messages.

In any combination of the above embodiments of the computer-implemented method, the method further includes generating a model prompt that includes the set of commit messages corresponding with the code; and inputting the model prompt into the trained large language model to generate the code development summary representing the set of commit messages.

In other embodiments, one or more computer storage media having computer-executable instructions embodied thereon that, when executed by one or more processors, cause the one or more processors to perform a method is provided. The method includes obtaining, at a trained large language model, a model prompt that includes an indication of a target audience and code modification data associated with code, wherein the code modification data comprises a description associated with a corresponding modification in the code. The method further includes generating, using the trained large language model, a code development summary that summarizes the code modification data associated with the code in accordance with the target audience. The method further includes providing the code development summary to a data store for subsequent presentation. In this way, embodiments, as described herein, enable efficient generation of code development summaries via use of a trained machine learning model, such as a large language model, without requiring fine-tuning of the model. Further, in this way, embodiments, as described herein, cause certain code development summaries associated with code to be programmatically surfaced and presented without requiring computer tools and resources for an individual to manually perform operations to produce this outcome.

In any combination of the above embodiments of the media, the model prompt further includes an output attribute to indicate a desired format or style for the code development summary.

In any combination of the above embodiments of the media, the target audience comprises a particular consumer audience or a particular code developer audience.

In any combination of the above embodiments of the media, the target audience is user specified or automatically determined based on a user desiring to view the code development summary.

In any combination of the above embodiments of the media, the method further includes providing the code development summary for display based on a request to view the code development summary.

Various examples are provided here and are not intended to be limiting to embodiments of the present technology. Further, the use of the term “set” refers to one or more, as used herein.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 6 in particular, an exemplary operating environment for implementing aspects of the technology described herein is shown and designated generally as computing device 600. Computing device 600 is just one example of a suitable computing environment and is not intended to suggest any limitation as to the scope of use or functionality of the technology described herein. Neither should the computing device 600 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, an illustrative power supply 622, and a radio(s) 624. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 6 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory 612 may be removable, non-removable, or a combination thereof. Exemplary memory includes solid-state memory, hard drives, and optical-disc drives. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, and vibrating component. I/O port(s) 618 allow computing device 600 to be logically coupled to other devices including I/O components 620, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 600. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include a radio(s) 624. The radio 624 transmits and receives radio communications. The computing device may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. A computing system comprising:
a processor; and
computer storage memory having computer-executable instructions stored thereon which, when executed by the processor, configure the computing system to perform operations comprising:
obtain commit message data for a set of commit messages associated with code, wherein each commit message comprises a description associated with a corresponding modification in the code;
generate a model prompt to be input into a large language model, the model prompt including at least a portion of the commit message data; and
obtain, as output from the large language model, a code development summary that summarizes the at least the portion of the commit message data for the set of commit messages associated with the code.

2. The computing system of claim 1, wherein the set of commit messages comprises commit messages corresponding with a start commit through an end commit associated with the code.

3. The computing system of claim 2, wherein the operations further comprise receiving a user selection of the start commit and the end commit.

4. The computing system of claim 2, wherein the start commit corresponds with a start of a new release of the code, and the end commit corresponds with an end of the new release of the code.

5. The computing system of claim 1, wherein the operations further comprise preprocessing the commit message data for including in the model prompt, wherein the preprocessing comprises removing or filtering undesired commit message data.

6. The computing system of claim 1, wherein the at least the portion of the commit message data is determined in accordance with an input prompt size constraint associated with the large language model.

7. The computing system of claim 1, wherein the model prompt includes an indication of a type of audience for which the code development summary is to be generated.

8. The computing system of claim 1, wherein the operations further comprise:
storing the code development summary that summarizes the at least the portion of the commit message data; and
in response to a request for the code development summary, providing at least a portion of the code development summary for display.

9. The computing system of claim 1, wherein the operations further comprise:
identifying a pull request identifier in a commit message of the set of commit messages;
obtaining information associated with the pull request identifier; and
including the information associated with the pull request identifier in the commit message data.

10. The computing system of claim 1, wherein the code development summary includes at least one link to a pull request associated with the at least the portion of the commit message data.

11. A computer-implemented method comprising:
providing a request to generate a code development summary in association with a set of commit messages corresponding with a code;
in response to the request, obtaining the code development summary representing the set of commit messages corresponding with the code, the code development summary being generated via a trained large language model; and
causing display, via a graphical user interface, of the code development summary in association with the code.

12. The method of claim 11 further comprising:
preprocessing a plurality of commit messages corresponding with the code to remove one or more commit messages;
selecting the set of commit messages from the preprocessed plurality of commit messages, wherein the set of commit messages are selected from the preprocessed plurality of commit messages based on at least one criteria associated with the commit messages.

13. The method of claim 11, wherein the request is automatically provided based on a new commit associated with the code.

14. The method of claim 11, wherein the request is automatically provided in response to a user selection, via the graphical user interface, of the set of commit messages.

15. The method of claim 11 further comprising:
generating a model prompt that includes the set of commit messages corresponding with the code; and
inputting the model prompt into the trained large language model to generate the code development summary representing the set of commit messages.

16. One or more computer storage media having computer-executable instructions embodied thereon that, when executed by one or more processors, cause the one or more processors to perform a method, the method comprising:
obtaining, at a trained large language model, a model prompt that includes an indication of a target audience and code modification data associated with code, wherein the code modification data comprises a description associated with a corresponding modification in the code;
generating, using the trained large language model, a code development summary that summarizes the code modification data associated with the code in accordance with the target audience; and
providing the code development summary to a data store for subsequent presentation.

17. The media of claim 16, wherein the model prompt further includes an output attribute to indicate a desired format or style for the code development summary.

18. The media of claim 16, wherein the target audience comprises a particular consumer audience or a particular code developer audience.

19. The media of claim 16, wherein the target audience is user specified or automatically determined based on a user desiring to view the code development summary.

20. The media of claim 16, wherein the method further comprises providing the code development summary for display based on a request to view the code development summary.
